(19) United States
(12) Patent Application Publication
(10) Pub. No.: US 2026/0336798 A1
(43) Pub. Date: Oct. 29, 2026

(54) LINEAR ACTUATOR INTEGRATED WITH GEAR NONIUS ENCODER AND CONTROL METHOD THEREFO

(71) Applicant: EHANG INTELLIGENT EQUIPMENT (GUANGZHOU) CO., LTD., Guangzhou (CN)

(72) Inventors: Huazhi HU, Guangzhou (CN); Haihui HU, Guangzhou (CN); Xingjie LU, Guangzhou (CN)

(73) Assignee: EHANG INTELLIGENT EQUIPMENT (GUANGZHOU) CO., LTD., Guangzhou (CN)

(21) Appl. No.: 19/110,825

(22) PCT Filed: Sep. 1, 2023
(86) PCT No.: PCT/CN2023/116553

§ 371 Date: Mar. 12, 2025

(30) Foreign Application Priority Data
Sep. 19, 2022 (CN) 202211138476.2

(51) Int. Cl. B64C 13/50; H02K 7/06; H02K 11/33; H02K 29/08; H02P 6/17

(52) U.S. Cl. CPC B64C 13/50; H02K 7/06; H02K 11/33; H02K 29/08; H02P 6/17

(57) ABSTRACT

A linear actuator integrated with a gear nonius encoder and a control method therefor are provided. The linear actuator includes a motor, a control circuit module, a gear nonius encoder and a ball screw pair. The gear nonius encoder includes a synchronous belt, a nonius gear, nonius gear magnetic steel, a nonius gear magnetic encoding chip, a master gear magnetic encoding chip, master gear magnetic steel and a master gear. The master gear is rotatably connected to the nonius gear. The control circuit module is electrically connected to the master gear magnetic encoding chip and the nonius gear magnetic encoding chip respectively, and reads single-turn angle values of the master gear and the nonius gear and the nonius gear magnetic encoding chip respectively. The nonius gear is connected to the ball screw pair. The control circuit module is electrically connected to the motor.

### CROSS REFERENCE TO THE RELATED APPLICATIONS

This application is the national phase entry of International Application No. PCT/CN2023/116553, filed on Sep. 1, 2023, which is based upon and claims priority to Chinese Patent Application No. 202211138476.2, filed on Sep. 19, 2022, the entire contents of which are incorporated herein by reference.

### TECHNICAL FIELD

The invention relates to the technical field of aircrafts, and in particular to a linear actuator integrated with a gear nonius encoder and a control method therefor.

### BACKGROUND

An actuator is a servo drive for position or angle control, which is widely used in aircrafts and other devices to control surface controls of an aircraft.

Linear electromechanical actuators (EMA) commonly used in small and medium-sized aircrafts are mainly divided into two types: (1) Limit switch solution: a permanent magnet synchronous motor, a rotor angle encoder, a gear box, a ball screw pair, a cylinder, a push rod and an internal limit switch are used. A controller controls the motor to rotate so as to drive the ball screw pair to reciprocate, but it is required to find the mechanical zero by means of the internal limit switch after power-on. This type of actuator is not suitable for high-safety aircrafts because it does not have an absolute position sensor. If the actuator is restarted in flight due to the failure of the controller, it takes a long time to perform mechanical zeroing, which may cause a crash of the aircraft. (2) Linear position sensor solution: a permanent magnet synchronous motor, a rotor angle encoder, a gear box, a ball screw pair, a cylinder, a push rod and a linear variable differential transformer (LVDT) are used. Since the linear variable differential transformer (LVDT) is used as the absolute position sensor, the actuator can work normally without mechanical zeroing after power-on. This type of actuator is suitable for high-safety aircrafts, but it needs an internal or external linear variable differential transformer (LVDT), causing the defects of complex manufacture, large size and high price.

### SUMMARY

In order to overcome the defects of complex manufacture, large size and high price in the linear actuators in the prior art, the invention provides a linear actuator integrated with a gear nonius encoder and a control method therefor. By reading the angle values on the master gear and the nonius gear, the current position of the push rod can be calculated, and there is no need to perform mechanical zeroing after power-on or add a linear variable differential transformer (LVDT). Thereby, the cost and mounting area are greatly reduced on the premise of ensuring high safety.

In order to achieve the above objective, the invention adopts the following technical solution:

A linear actuator integrated with a gear nonius encoder includes a permanent magnet synchronous motor, a control circuit module, a gear nonius encoder and a ball screw pair for pushing a push rod to reciprocate.

The gear nonius encoder includes a synchronous belt, a nonius gear with N+1 teeth, nonius gear magnetic steel, a nonius gear magnetic encoding chip, a master gear magnetic encoding chip, master gear magnetic steel and a master gear with N teeth.

The master gear is assembled on a rotor shaft of the permanent magnet synchronous motor. The master gear is rotatably connected to the nonius gear by means of the synchronous belt.

The master gear magnetic steel and the nonius gear magnetic steel are correspondingly mounted on the master gear and the nonius gear respectively.

The master gear magnetic encoding chip and the nonius gear magnetic encoding chip are correspondingly placed below the master gear magnetic steel and the nonius gear magnetic steel respectively.

The control circuit module is electrically connected to the master gear magnetic encoding chip and the nonius gear magnetic encoding chip respectively, and reads single-turn angle values of the master gear and the nonius gear by means of the master gear magnetic encoding chip and the nonius gear magnetic encoding chip respectively.

The nonius gear is connected to the ball screw pair, and with rotation of the nonius gear, the ball screw pair pushes the push rod to reciprocate.

The control circuit module is electrically connected to the permanent magnet synchronous motor, and controls the motor to rotate according to the single-turn angle values of the master gear and the nonius gear and a control signal.

Preferably, the control circuit module includes a controller and an inverter circuit.

The master gear magnetic encoding chip and the nonius gear magnetic encoding chip are electrically connected to the controller respectively.

An output of the controller is electrically connected to an input of the inverter circuit to output pulse width modulation signals to the inverter circuit.

A first output of the inverter circuit is electrically connected to the motor.

A second output of the inverter circuit is electrically connected to the controller to feed current information back to the controller.

Further, the linear actuator further includes a mounting plate. An end of the motor connected to the master gear and an end of the ball screw pair connected to the nonius gear are both connected to the mounting plate, and the motor and the ball screw pair are arranged on one side of the mounting plate in parallel.

Preferably, the linear actuator further includes a bottom case provided with an accommodating cavity. The bottom case is detachably connected to the mounting plate, and the control circuit module and the gear nonius encoder are both located in the accommodating cavity of the bottom case.

Preferably, the linear actuator further includes a printed circuit board (PCB). The control circuit module, the master gear magnetic encoding chip and the nonius gear magnetic encoding chip are all arranged on the PCB.

Preferably, the linear actuator further includes a master gear magnetic steel sheath for protecting the master gear magnetic steel and a nonius gear magnetic steel sheath for protecting the nonius gear magnetic steel.

The master gear magnetic steel is connected to the master gear by means of the master gear magnetic steel sheath.

The nonius gear magnetic steel is connected to the nonius gear by means of the nonius gear magnetic steel sheath.

A control method for the linear actuator integrated with a gear nonius encoder includes: reading the single-turn angle values of the master gear and the nonius gear by means of the master gear magnetic encoding chip and the nonius gear magnetic encoding chip respectively;
calculating a number of revolutions of the motor according to a linear relationship between a difference between single-turn angles of the master gear and the nonius gear and the number of revolutions of the permanent magnet synchronous motor, and calculating position information of the push rod based on a lead of the ball screw pair; and
outputting a set of pulse width modulation signals PWM according to received control information and the position information of the push rod to control the permanent magnet synchronous motor to rotate, thus pushing the push rod to reciprocate.

Preferably, the outputting the set of pulse width modulation signals PWM according to the received control information and the position information of the push rod to control the permanent magnet synchronous motor to rotate specifically includes:
calculating speed information based on the control information and the position information of the push rod after receiving the control information;
calculating first current information according to the speed information and rotational speed information of the nonius gear;
calculating a set of direct-axis voltage Vd and quadrature-axis voltage Vq according to the first current information and received feedback second current information; and
outputting the set of pulse width modulation signals PWM according to the direct-axis voltage Vd, the quadrature-axis voltage Vq and the single-turn angle value of the master gear to control the permanent magnet synchronous motor to rotate, thus pushing the push rod to reciprocate.

Further, formulae for calculating the position information of the push rod are as follows:

$${N}_{nonius} = {N}_{master} + 1 \qquad ( 1 )$$

$${θ}_{nonius} = \frac{{N}_{master}}{{N}_{nonius}} * {θ}_{master} \qquad ( 2 )$$

$$\{ \begin{matrix}{θ}_{ReadMaster} = MOD ( {θ}_{master} , 360 ) \\ {θ}_{ReadNonius} = MOD ( {θ}_{nonius} , 360 )\end{matrix} \qquad ( 3 )$$

$$Δθ = \{ \begin{matrix}{θ}_{ReadMaster} - {θ}_{ReadNonius} , & {θ}_{ReadMaster} \geq {θ}_{ReadNonius} \\ {θ}_{ReadMaster} + 360 ° - {θ}_{ReadNonius} , & {θ}_{ReadMaster} < {θ}_{ReadNonius}\end{matrix} \qquad ( 4 )$$

$$n = INT ( \frac{Δθ * {N}_{nonius}}{360 °} ) \qquad ( 5 )$$

$${θ}_{CalcMaster} = n * 360 ° + {θ}_{ReadMaster} \qquad ( 6 )$$

$$\{ \begin{matrix}{S}_{real} = \frac{{θ}_{master}}{360 °} * {P}_{B} \\ {S}_{calc} = \frac{{θ}_{CalcMaster}}{360 °} * {P}_{B}\end{matrix} \qquad ( 7 )$$

where Nₘₐₛₜₑᵣ denotes a number of teeth of the master gear; Nₙₒₙᵢᵤₛ denotes a number of teeth of the nonius gear; θₘₐₛₜₑᵣ denotes a multi-turn angle of the master gear; Nₙₒₙᵢᵤₛ denotes a multi-turn angle of the nonius gear; MOD denotes a function to find a remainder; θ_{ReadMaster} denotes a single-turn angle of the master gear; θ_{ReadNonius} denotes a single-turn angle of the nonius gear; Δθ denotes a difference between single-turn angles of the master gear and the nonius gear; INT denotes a rounddown function; n denotes a number of revolutions of the master gear, a range of n being n∈[0, Nₙₒₙᵢᵤₛ); θ_{CalcMaster} denotes a calculated multi-turn angle value of the master gear; P_{B} denotes the lead of the ball screw pair; Sᵣₑₐₗ denotes an actual position of the push rod; and S_{calc} denotes a calculated position of the push rod.

An aircraft includes a fuselage, a flight control system, the linear actuator, a control surface and the push rod.

The flight controller is electrically connected to the control circuit module and sends the control information to the control circuit module.

One end of the control surface is rotatably connected to the fuselage, and the ball screw pair is rotatably connected to a middle of the control surface by means of the push rod.

The linear actuator implements the control method to realize controlled control surface steering.

The invention has the following beneficial effects:

Compared with the linear position sensor solution in the prior art which has the defects of complex manufacture, large size and high price due to the need for the internal or external linear variable differential transformer (LVDT), the linear actuator in this embodiment does not need to use a linear variable differential transformer or a gear box, which makes the connection of the overall structure simpler. It is only required to add a nonius gear which is connected to the gear through a synchronous belt. This method has the advantages of simple manufacture, small size and low price, and does not need to use a limit switch or a linear variable differential transformer (LVDT) for position detection as compared with the traditional linear actuator, thereby lowering the cost and improving the reliability. Thereby, the cost and mounting area are greatly reduced on the premise of ensuring high safety.

According to the invention, by reading the difference between angles of the master gear magnetic encoding chip and the nonius gear magnetic encoding chip, the number of revolutions of the permanent magnet synchronous motor can be calculated and used for multi-turn counting, and the angle value of the master gear magnetic encoding chip is read for the single-turn absolute angle, thereby forming a multi-turn absolute value encoder without a standby battery. Compared with the traditional multi-turn absolute value encoder, the invention does not need a standby battery to maintain counting, thereby improving the reliability.

### BRIEF DESCRIPTION OF THE DRAWINGS

FIG. 1 is a schematic exploded view of a linear actuator integrated with a gear nonius encoder according to this embodiment:

FIG. 2 is a schematic view showing the overall appearance of the linear actuator integrated with a gear nonius encoder according to this embodiment;

FIG. 3 is a schematic view of gears connected with the gear nonius encoder according to this embodiment;

FIG. 4 is a schematic control diagram of the linear actuator according to this embodiment;

FIG. 5 shows the relationship between a number of revolutions of a permanent magnet synchronous motor and an angle of a magnetic encoder;

FIG. 6 shows the relationship between the number of revolutions of the permanent magnet synchronous motor and a calculated number of turns;

FIG. 7 shows the relationship between the number of revolutions of the permanent magnet synchronous motor and a position of a push rod; and

FIG. 8 is a schematic overall diagram of an aircraft.

In the figures, 1—controller, 2—nonius gear, 3—master gear, 4—synchronous belt, 5—master gear magnetic steel, 6—nonius gear magnetic steel, 7—master gear magnetic encoding chip, 8—nonius gear magnetic encoding chip, 9—permanent magnet synchronous motor, 10—master gear magnetic steel sheath, 11—nonius gear magnetic steel sheath, 12—mounting plate, 13—bottom case, 14—cylinder, 15—push rod, 16—PCB, 17—fuselage.

### DETAILED DESCRIPTION OF THE EMBODIMENTS

The invention will be described in detail below in conjunction with the accompanying drawings and specific implementations.

### Embodiment 1

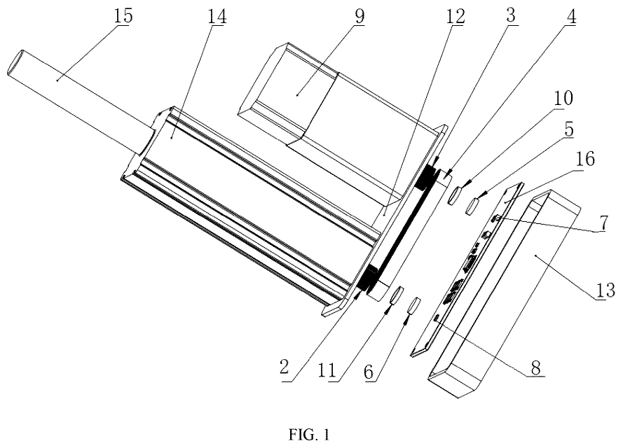

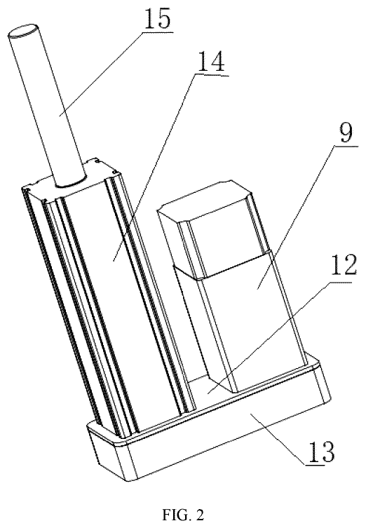

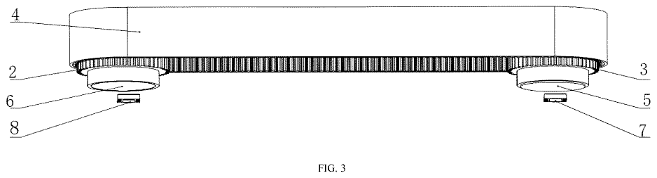

As shown in FIG. 1, FIG. 2 and FIG. 3, a linear actuator integrated with a gear nonius encoder includes a permanent magnet synchronous motor 9, a control circuit module, a gear nonius encoder and a ball screw pair for pushing a push rod 15 to reciprocate.

The gear nonius encoder includes a synchronous belt 4, a nonius gear 2 with N+1 teeth, nonius gear magnetic steel 6, a nonius gear magnetic encoding chip 8, a master gear magnetic encoding chip 7, master gear magnetic steel 5 and a master gear 3 with N teeth.

The master gear 3 is assembled on a rotor shaft of the permanent magnet synchronous motor 9. The master gear 3 is rotatably connected to the nonius gear 2 by means of the synchronous belt 4.

The master gear magnetic steel 5 and the nonius gear magnetic steel 6 are correspondingly mounted on the master gear 3 and the nonius gear 2 respectively.

The master gear magnetic encoding chip 7 and the nonius gear magnetic encoding chip 8 are correspondingly placed below the master gear magnetic steel 5 and the nonius gear magnetic steel 6 respectively.

The control circuit module is electrically connected to the master gear magnetic encoding chip 7 and the nonius gear magnetic encoding chip 8 respectively, and reads single-turn angle values of the master gear 3 and the nonius gear 2 by means of the master gear magnetic encoding chip 7 and the nonius gear magnetic encoding chip 8 respectively.

The nonius gear 2 is connected to the ball screw pair, and with rotation of the nonius gear 2, the ball screw pair pushes the push rod to reciprocate.

The control circuit module is electrically connected to the permanent magnet synchronous motor 9, and controls the motor to rotate according to the single-turn angle values of the master gear 3 and the nonius gear 2 and a control signal.

Compared with the linear position sensor solution in the prior art which has the defects of complex manufacture, large size and high price due to the need for the internal or external linear variable differential transformer (LVDT), the linear actuator in this embodiment does not need to use a linear variable differential transformer or a gear box, which makes the connection of the overall structure simpler. It is only required to add a nonius gear 2 which is connected to the gear through a synchronous belt 4. This method has the advantages of simple manufacture, small size and low price, and does not need to use a limit switch or a linear variable differential transformer (LVDT) for position detection as compared with the traditional linear actuator, thereby lowering the cost and improving the reliability. Thereby, the cost and mounting area are greatly reduced on the premise of ensuring high safety.

In a specific embodiment, the control circuit module includes a controller 1 and an inverter circuit.

The master gear magnetic encoding chip 7 and the nonius gear magnetic encoding chip 8 are electrically connected to the controller 1 respectively.

An output of the controller 1 is electrically connected to an input of the inverter circuit to output pulse width modulation signals to the inverter circuit.

A first output of the inverter circuit is electrically connected to the motor.

A second output of the inverter circuit is electrically connected to the controller 1 to feed current information back to the controller 1.

The controller 1 is a single chip microcomputer. The single chip microcomputer is an integrated circuit chip, which is a small and complete microcomputer system formed by integrating a central processing unit (CPU) with data processing capability, a random access memory (RAM), a read-only memory (ROM), a variety of I/O ports and interrupt systems, a timer/counter and other functions (which may further include a display driver circuit, a pulse width modulation circuit, an analog multiplexer, an A/D converter and other circuits) onto a silicon wafer by very large scale integration technology. This embodiment may use, for example, an STM single chip microcomputer.

In this embodiment, the permanent magnet synchronous motor 9 uses permanent magnets to provide excitation, which makes the motor structure simpler and reduces the fabrication and assembly costs. Collector rings and brushes that are prone to errors are eliminated, which improves the operation reliability of the motor. Moreover, as there is no need for an excitation current, there is no excitation loss, thereby improving the efficiency and power density of the motor.

In order to fix the motor and the ball screw pair in parallel, the linear actuator further includes a mounting plate 12. An end of the motor connected to the master gear 3 and an end of the ball screw pair connected to the nonius gear 2 are both connected to the mounting plate 12, and the motor and the ball screw pair are arranged on one side of the mounting plate 12 in parallel.

In this embodiment, the motor and the ball screw pair are fixed together stably by means of the mounting plate 12, which is equivalent to fixing the distance between the nonius gear 2 and the master gear 3, thereby preventing the synchronous belt 4 from coming off the master gear 3 and the nonius gear 2.

As shown in FIG. 3, in this embodiment, the master gear 3 is provided with N teeth, and the nonius gear 2 is provided with N+1 teeth. The master gear 3 with N teeth drives the nonius gear 2 with N+1 teeth to rotate by means of the synchronous belt 4. Correspondingly, an inner side of the synchronous belt 4 is also provided with gear teeth for meshing with the master gear 3 and the nonius gear 2.

In a specific embodiment, as shown in FIG. 1 and FIG. 2, the linear actuator further includes a bottom case 13 provided with an accommodating cavity. The bottom case 13 is detachably connected to the mounting plate 12, and the control circuit module and the gear nonius encoder are both located in the accommodating cavity of the bottom case 13.

The bottom case 13 may be threadedly connected to the mounting plate 12 by means of screws, and the bottom case 13 and the mounting plate 12 are matched with each other to form a sealed cavity for protecting the control circuit module and the gear nonius encoder.

In a specific embodiment, the linear actuator further includes a PCB 14. The control circuit module, the master gear magnetic encoding chip 7 and the nonius gear magnetic encoding chip 8 are all arranged on the PCB 14.

In a specific embodiment, the ball screw pair includes a screw shaft and a nut threadedly connected to the screw shaft. In this embodiment, a cylinder 14 and the push rod are additionally provided. The ball screw pair is arranged inside the cylinder 14, one end of the screw shaft is connected to the nonius gear, and the nut is connected to the push rod. With the rotation of the nonius gear 2, the screw shaft rotates to drive the nut to move forward or backward, thereby pushing the push rod to reciprocate. The cylinder 14 functions to protect the ball screw pair, thereby preventing dust from entering and affecting the connection between the screw shaft and the nut.

In a specific embodiment, the linear actuator further includes a master gear magnetic steel sheath 10 for protecting the master gear magnetic steel and a nonius gear magnetic steel 6 sheath for protecting the nonius gear magnetic steel.

The master gear magnetic steel is connected to the master gear 3 by means of the master gear magnetic steel sheath 10.

The nonius gear magnetic steel is connected to the nonius gear 3 by means of the nonius gear magnetic steel 6 sheath.

### Embodiment 2

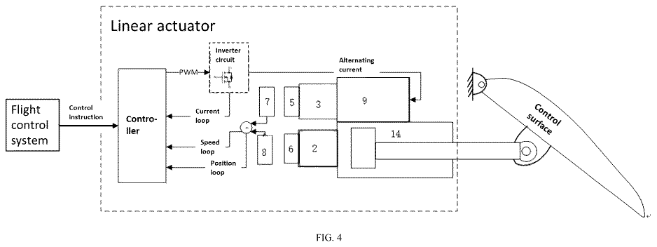

Based on the linear actuator integrated with a gear nonius encoder in Embodiment 1, as shown in FIG. 4, this embodiment further provides a control method for the linear actuator integrated with a gear nonius encoder, including:
reading the single-turn angle values of the master gear 3 and the nonius gear 2 by means of the master gear magnetic encoding chip 7 and the nonius gear magnetic encoding chip 8 respectively;
calculating a number of revolutions of the motor according to a linear relationship between a difference between single-turn angles of the master gear 3 and the nonius gear 2 and the number of revolutions of the permanent magnet synchronous motor 9, and calculating position information of the push rod 15 based on a lead of the ball screw pair; and
outputting a set of pulse width modulation signals PWM according to received control information and the position information of the push rod 15 to control the permanent magnet synchronous motor 9 to rotate, thus pushing the push rod 15 to reciprocate.

Preferably, the outputting the set of pulse width modulation signals PWM according to the received control information and the position information of the push rod 15 to control the permanent magnet synchronous motor 9 to rotate specifically includes:
calculating speed information based on the control information and the position information of the push rod 15 after receiving the control information;
calculating first current information according to the speed information and rotational speed information of the nonius gear 2;
calculating a set of direct-axis voltage Vd and quadrature-axis voltage Vq according to the first current information and received feedback second current information; and outputting the set of pulse width modulation signals PWM according to the direct-axis voltage Vd, the quadrature-axis voltage Vq and the single-turn angle value of the master gear 3 to control the permanent magnet synchronous motor 9 to rotate, thus pushing the push rod 15 to reciprocate.

In this embodiment, in the inverter circuit, the pulse width modulation signals PWM are amplified by the inverter circuit to output a three-phase alternating current to the permanent magnet synchronous motor 9. The permanent magnet synchronous motor 9 rotates under the excitation of the three-phase alternating current, and at the same time, the master gear magnetic steel 5 on the rotor shaft of the permanent magnet synchronous motor 9 rotates while the position of the rotor shaft is outputted to the controller 1 by means of the master gear magnetic encoding chip 7. The master gear 3 drives the nonius gear 2 to rotate by means of the synchronous belt 4, and at the same time, the nonius gear magnetic steel 6 on the nonius gear 2 rotates while the position of the nonius gear 2 is outputted to the controller 1 by means of the nonius gear magnetic encoding chip 8. The ball screw pair in the cylinder 14 rotates along with the nonius gear 2, thereby pushing the push rod 15 to reciprocate.

In a specific embodiment, in the linear actuator, the master gear 3 is assembled on the rotor shaft of the permanent magnet synchronous motor 9 and rotates with the permanent magnet synchronous motor 9, and the master gear 3 with N teeth drives the nonius gear 2 with N+1 teeth to rotate by means of the synchronous belt 4. Since there is a difference of 1 tooth between the master gear 3 and the nonius gear 2, within a certain range of the number of revolutions of the motor, the difference between single-turn angles of the master gear 3 and the nonius gear 2 has a linear relationship with the number of revolutions of the permanent magnet synchronous motor 9 (the difference between single-turn angles of the master gear 3 and the nonius gear 2 Δθ∝the number of revolutions n of the permanent magnet synchronous motor 9). Thereby, the number of revolutions of the permanent magnet synchronous motor 9 can be calculated by reading the single-turn angle values of the master gear 3 and the nonius gear 2, and then the position of the push rod 15 can be calculated based on the lead of the ball screw pair. The formulae for calculating the position information of the push rod 15 are as follows:

$${N}_{nonius} = {N}_{master} + 1 \qquad ( 1 )$$

$${θ}_{nonius} = \frac{{N}_{master}}{{N}_{nonius}} * {θ}_{master} \qquad ( 2 )$$

$$\{ \begin{matrix}{θ}_{ReadMaster} = MOD ( {θ}_{master} , 360 ) \\ {θ}_{ReadNonius} = MOD ( {θ}_{nonius} , 360 )\end{matrix} \qquad ( 3 )$$

$$Δθ = \{ \begin{matrix}{θ}_{ReadMaster} - {θ}_{ReadNonius} , & {θ}_{ReadMaster} \geq {θ}_{ReadNonius} \\ {θ}_{ReadMaster} + 360 ° - {θ}_{ReadNonius} , & {θ}_{ReadMaster} < {θ}_{ReadNonius}\end{matrix} \qquad ( 4 )$$

$$n = INT ( \frac{Δθ * {N}_{nonius}}{360 °} ) \qquad ( 5 )$$

$${θ}_{CalcMaster} = n * 360 ° + {θ}_{ReadMaster} \qquad ( 6 )$$

$$\{ \begin{matrix}{S}_{real} = \frac{{θ}_{master}}{360 °} * {P}_{B} \\ {S}_{calc} = \frac{{θ}_{CalcMaster}}{360 °} * {P}_{B}\end{matrix} \qquad ( 7 )$$

where Nₘₐₛₜₑᵣ denotes a number of teeth of the master gear 3; Nₙₒₙᵢᵤₛ denotes a number of teeth of the nonius gear 2; θₘₐₛₜₑᵣ denotes a multi-turn angle of the master gear 3; θₙₒₙᵢᵤₛ denotes a multi-turn angle of the nonius gear 2; MOD denotes a function to find a remainder; θ_{ReadMaster} denotes a single-turn angle of the master gear 3; θ_{ReadNonius} denotes a single-turn angle of the nonius gear 2; Δθ denotes a difference between single-turn angles of the master gear 3 and the nonius gear 2; INT denotes a rounddown function; n denotes a number of revolutions of the master gear 3, a range of n being n E [0, Nₙₒₙᵢᵤₛ); θ_{CalcMaster} denotes a calculated multi-turn angle value of the master gear 3; P_{B} denotes the lead of the ball screw pair; Sᵣₑₐₗ denotes an actual position of the push rod 15; and S_{calc} denotes a calculated position of the push rod 15.

Based on the formulae (1) to (7), the current position of the push rod 15 can be calculated by means of the gear nonius encoder. For example, by using a gear nonius encoder including a master gear 3 with 10 teeth and a nonius gear 2 with 11 teeth, the position of the push rod 15 can be obtained through the following calculations:
1. Assuming that the number of teeth of the master gear 3 is Nₘₐₛₜₑᵣ=10, based on formula (1), the number of teeth of the nonius gear 2 is Nₙₒₙᵢᵤₛ=10+1=11.
2. Assuming that the master gear 3 rotates for 10.1 turns, then the multi-turn angle of the master gear 3 is θₘₐₛₜₑᵣ=3636°, and based on formula (2), the multi-turn angle of the nonius gear 2 is

$${θ}_{nonius} = \frac{10}{11} * 3636 ° = 3305.45 ° .$$

3. Based on formula (3), the single-turn angle of the master gear 3 read by the magnetic encoding chip is θ_{ReadMaster}=360, and the single-turn angle of the nonius gear 2 read by the magnetic encoding chip is θ_{ReadNonius}=65.45°.
4. Based on formula (4), the difference between single-turn angles read by the master gear magnetic encoding chip 7 and nonius gear magnetic encoding chip 8 is Δθ=330.54°.
5. Based on formula (5), the number of revolutions of the master gear 3 is n=10.
6. Based on formula (6), the calculated multi-turn angle of the master gear 3 is θ_{CalcMaster}=10*360°+36°=3636°, i.e., θ_{CalcMaster} is equal to θₘₐₛₜₑᵣ.
7. Assuming that the lead of the ball screw pair is P_{B}=2 mm, based on formula (7), the actual position of the push rod 15 is

$${S}_{real} = \frac{3636 °}{360 °} * 2 mm = 20.2 mm ,$$

and the calculated position of the push rod 15 is

$${S}_{calc} = \frac{3636 °}{360 °} * 2 mm = 20.2 mm ,$$

i.e., Sᵣₑₐₗ is equal to S_{calc}, so the actual position of the push rod 15 in the linear actuator can be calculated by means of the gear nonius encoder.

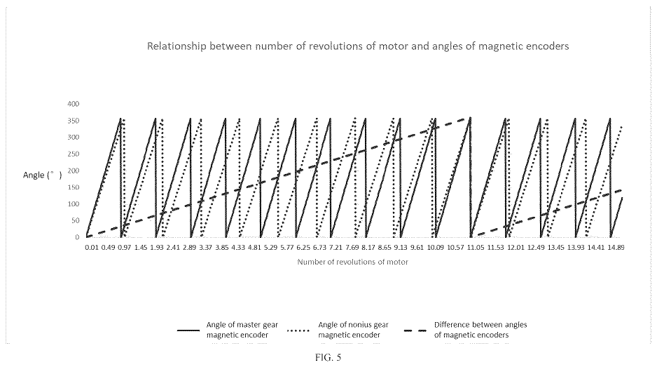

FIG. 5 shows the relationship between the angles of the master gear 3 and the nonius gear 2 when the motor rotates.

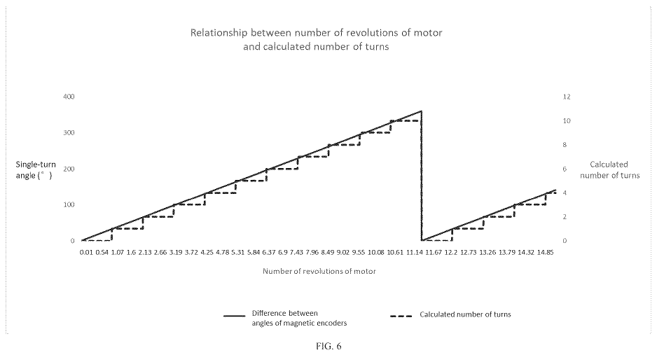

As shown in FIG. 6, when the motor rotates, the current number of revolutions of the motor can be obtained by calculating the difference between angles of the master gear 3 and the nonius gear 2.

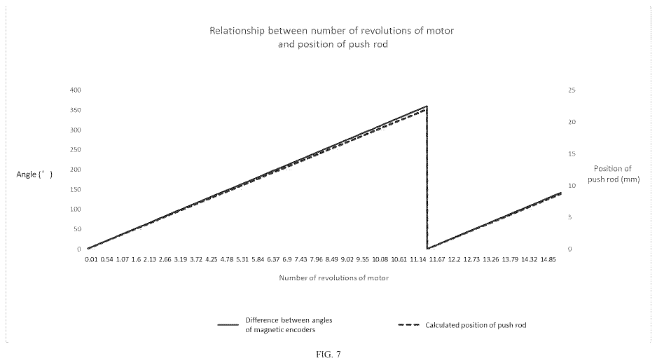

As shown in FIG. 7, when the motor rotates, the position of the push rod 15 has a linear relationship with the difference between angles of the magnetic encoders, and the position of the push rod 15 can be obtained by means of the gear nonius encoder.

### Embodiment 3

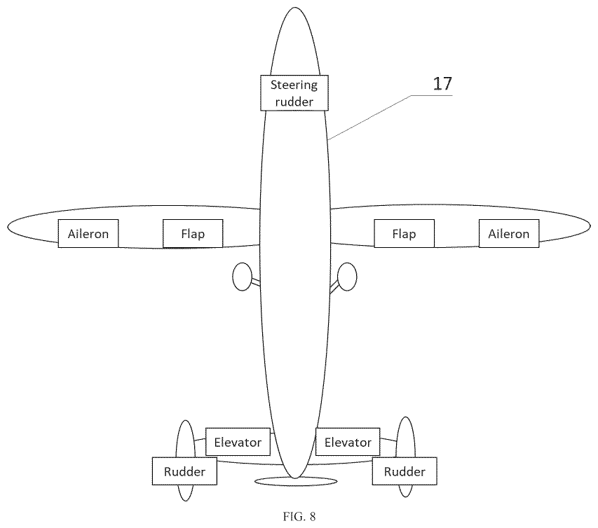

As shown in FIG. 8, an aircraft includes a fuselage 17, a flight control system, the linear actuator according to Embodiment 1, a control surface and the push rod.

The flight controller 1 is electrically connected to the control circuit module and sends the control information to the control circuit module.

One end of the control surface is rotatably connected to the fuselage 17, and the ball screw pair is rotatably connected to a middle of the control surface by means of the push rod 15.

The linear actuator implements the control method according to Embodiment 2 to realize controlled control surface steering.

The control surface in this embodiment may be an elevator, that is, the elevator of the aircraft may be controlled by controlling the linear actuator.

Apparently, the above embodiments of the invention are merely examples for clearly explaining the invention, and are not limitations to the implementations of the invention. Any modification, equivalent substitution, or improvement made within the spirit and principle of the invention shall fall into the protection scope of the claims of the invention.

What is claimed is:

1. A linear actuator integrated with a gear nonius encoder, comprising a permanent magnet synchronous motor, a control circuit module, the gear nonius encoder and a ball screw pair for pushing a push rod to reciprocate;
wherein the gear nonius encoder comprises a synchronous belt, a nonius gear with N+1 teeth, a nonius gear magnetic steel, a nonius gear magnetic encoding chip, a master gear magnetic encoding chip, a master gear magnetic steel and a master gear with N teeth;
the master gear is assembled on a rotor shaft of the permanent magnet synchronous motor; the master gear is rotatably connected to the nonius gear by the synchronous belt;
the master gear magnetic steel and the nonius gear magnetic steel are correspondingly mounted on the master gear and the nonius gear respectively;
the master gear magnetic encoding chip and the nonius gear magnetic encoding chip are correspondingly placed below the master gear magnetic steel and the nonius gear magnetic steel respectively;
the control circuit module is electrically connected to the master gear magnetic encoding chip and the nonius gear magnetic encoding chip respectively, and reads a single-turn angle value of the master gear and a single-turn angle value of the nonius gear by the master gear magnetic encoding chip and the nonius gear magnetic encoding chip respectively;
the nonius gear is connected to the ball screw pair, and with a rotation of the nonius gear, the ball screw pair pushes the push rod to reciprocate; and
the control circuit module is electrically connected to the permanent magnet synchronous motor, and controls the permanent magnet synchronous motor to rotate according to the single-turn angle value of the master gear and the single-turn angle value of the nonius gear and a control signal.

2. The linear actuator according to claim 1, wherein the control circuit module comprises a controller and an inverter circuit;
the master gear magnetic encoding chip and the nonius gear magnetic encoding chip are electrically connected to the controller respectively;
an output of the controller is electrically connected to an input of the inverter circuit to output pulse width modulation signals to the inverter circuit;
a first output of the inverter circuit is electrically connected to the permanent magnet synchronous motor; and
a second output of the inverter circuit is electrically connected to the controller to feed current information back to the controller.

3. The linear actuator according to claim 2, further comprising a mounting plate; and an end of the permanent magnet synchronous motor connected to the master gear and an end of the ball screw pair connected to the nonius gear are both connected to the mounting plate, and the permanent magnet synchronous motor and the ball screw pair are arranged on a side of the mounting plate in parallel.

4. The linear actuator according to claim 1, further comprising a bottom case provided with an accommodating cavity; and the bottom case is detachably connected to a mounting plate, and the control circuit module and the gear nonius encoder are both located in the accommodating cavity of the bottom case.

5. The linear actuator according to claim 4, further comprising a printed circuit board (PCB), wherein the control circuit module, the master gear magnetic encoding chip and the nonius gear magnetic encoding chip are all arranged on the PCB.

6. The linear actuator according to claim 1, further comprising a master gear magnetic steel sheath for protecting the master gear magnetic steel and a nonius gear magnetic steel sheath for protecting the nonius-master gear magnetic steel;
the master gear magnetic steel is connected to the master gear by the master gear magnetic steel sheath; and
the nonius gear magnetic steel is connected to the nonius gear by the nonius gear magnetic steel sheath.

7. A control method for the linear actuator according to claim 1, comprising the following steps:
reading the single-turn angle value of the master gear and the single-turn angle value of the nonius gear by the master gear magnetic encoding chip and the nonius gear magnetic encoding chip respectively;
calculating a number of revolutions of the permanent magnet synchronous motor according to a linear relationship between a difference between a single-turn angle of the master gear and a single-turn angle of the nonius gear and the number of revolutions of the permanent magnet synchronous motor, and calculating position information of the push rod based on a lead of the ball screw pair; and
outputting a set of pulse width modulation signals PWM according to received control information and the position information of the push rod to control the permanent magnet synchronous motor to rotate, pushing the push rod to reciprocate.

8. The control method according to claim 7, wherein the step of outputting the set of pulse width modulation signals PWM according to the received control information and the position information of the push rod to control the permanent magnet synchronous motor to rotate comprises:
calculating speed information based on the received control information and the position information of the push rod after receiving control information;
calculating first current information according to the speed information and rotational speed information of the nonius gear;
calculating a set of direct-axis voltage Vd and quadrature-axis voltage Vq according to the first current information and received feedback second current information; and
outputting the set of pulse width modulation signals PWM according to the set of direct-axis voltage Vd and quadrature-axis voltage Vq and the single-turn angle value of the master gear to control the permanent magnet synchronous motor to rotate, pushing the push rod to reciprocate.

9. The control method according to claim 7, wherein formulae for calculating the position information of the push rod are as follows:
$${N}_{nonius} = {N}_{master} + 1 \qquad ( 1 )$$
$${θ}_{nonius} = \frac{{N}_{master}}{{N}_{nonius}} * {θ}_{master} \qquad ( 2 )$$
$$\{ \begin{matrix}{θ}_{ReadMaster} = MOD ( {θ}_{master} , 360 ) \\ {θ}_{ReadNonius} = MOD ( {θ}_{nonius} , 360 )\end{matrix} \qquad ( 3 )$$
$$Δθ = \{ \begin{matrix}{θ}_{ReadMaster} - {θ}_{ReadNonius} , & {θ}_{ReadMaster} \geq {θ}_{ReadNonius} \\ {θ}_{ReadMaster} + 360 ° - {θ}_{ReadNonius} , & {θ}_{ReadMaster} < {θ}_{ReadNonius}\end{matrix} \qquad ( 4 )$$
$$n = INT ( \frac{Δθ * {N}_{nonius}}{360 °} ) \qquad ( 5 )$$
$${θ}_{CalcMaster} = n * 360 ° + {θ}_{ReadMaster} \qquad ( 6 )$$
$$\{ \begin{matrix}{S}_{real} = \frac{{θ}_{master}}{360 °} * {P}_{B} \\ {S}_{calc} = \frac{{θ}_{CalcMaster}}{360 °} * {P}_{B}\end{matrix} \qquad ( 7 )$$
wherein Nₘₐₛₜₑᵣ denotes a number of teeth of the master gear; Nₙₒₙᵢᵤₛ denotes a number of teeth of the nonius gear; θₘₐₛₜₑᵣ denotes a multi-turn angle of the master gear; θₙₒₙᵢᵤₛ denotes a multi-turn angle of the nonius gear; MOD denotes a function to find a remainder; θ_{ReadMaster} denotes the single-turn angle of the master gear; θ_{ReadNonius} denotes the single-turn angle of the nonius gear; Δθ denotes the difference between the single-turn angle of the master gear and the single-turn angle of the nonius gear; INT denotes a rounddown function; n denotes a number of revolutions of the master gear, a range of n being n∈[0, Nₙₒₙᵢᵤₛ); θ_{CalcMaster} denotes a calculated multi-turn angle value of the master gear; P_{B} denotes the lead of the ball screw pair; Sᵣₑₐₗ denotes an actual position of the push rod; and S_{calc} denotes a calculated position of the push rod.

10. An aircraft, comprising a fuselage, a flight control system, the linear actuator according to claim 1, a control surface and the push rod; wherein
a flight controller is electrically connected to the control circuit module and sends control information to the control circuit module;
an end of the control surface is rotatably connected to the fuselage, and the ball screw pair is rotatably connected to a middle of the control surface by the push rod; and
the linear actuator implements a control method to realize the control surface steering, wherein the control method comprises the following steps:
reading the single-turn angle value of the master gear and the single-turn angle value of the nonius gear by the master gear magnetic encoding chip and the nonius gear magnetic encoding chip respectively;
calculating a number of revolutions of the permanent magnet synchronous motor according to a linear relationship between a difference between a single-turn angle of the master gear and a single-turn angle of the nonius gear and the number of revolutions of the permanent magnet synchronous motor, and calculating position information of the push rod based on a lead of the ball screw pair; and
outputting a set of pulse width modulation signals PWM according to received control information and the position information of the push rod to control the permanent magnet synchronous motor to rotate, pushing the push rod to reciprocate;
wherein the step of outputting the set of pulse width modulation signals PWM according to the received control information and the position information of the push rod to control the permanent magnet synchronous motor to rotate comprises:
calculating speed information based on the received control information and the position information of the push rod after receiving control information;
calculating first current information according to the speed information and rotational speed information of the nonius gear;
calculating a set of direct-axis voltage Vd and quadrature-axis voltage Vg according to the first current information and received feedback second current information; and
outputting the set of pulse width modulation signals PWM according to the set of direct-axis voltage Vd and quadrature-axis voltage Vg and the single-turn angle value of the master gear to control the permanent magnet synchronous motor to rotate, pushing the push rod to reciprocate.

11. An aircraft, comprising a fuselage, a flight control system, the linear actuator according to claim 1, a control surface and the push rod; wherein
a flight controller is electrically connected to the control circuit module and sends control information to the control circuit module;
an end of the control surface is rotatably connected to the fuselage, and the ball screw pair is rotatably connected to a middle of the control surface by the push rod; and
the linear actuator implements a control method to realize the control surface steering, wherein the control method comprises the following steps:
reading the single-turn angle value of the master gear and the single-turn angle value of the nonius gear by the master gear magnetic encoding chip and the nonius gear magnetic encoding chip respectively;
calculating a number of revolutions of the permanent magnet synchronous motor according to a linear relationship between a difference between a single-turn angle of the master gear and a single-turn angle of the nonius gear and the number of revolutions of the permanent magnet synchronous motor, and calculating position information of the push rod based on a lead of the ball screw pair; and
outputting a set of pulse width modulation signals PWM according to received control information and the position information of the push rod to control the permanent magnet synchronous motor to rotate, pushing the push rod to reciprocate;
wherein formulae for calculating the position information of the push rod are as follows:
$${N}_{nonius} = {N}_{master} + 1 \qquad ( 1 )$$
$${θ}_{nonius} = \frac{{N}_{master}}{{N}_{nonius}} * {θ}_{master} \qquad ( 2 )$$
$$\{ \begin{matrix}{θ}_{ReadMaster} = MOD ( {θ}_{master} , 360 ) \\ {θ}_{ReadNonius} = MOD ( {θ}_{nonius} , 360 )\end{matrix} \qquad ( 3 )$$
$$Δθ = \{ \begin{matrix}{θ}_{ReadMaster} - {θ}_{ReadNonius} , & {θ}_{ReadMaster} \geq {θ}_{ReadNonius} \\ {θ}_{ReadMaster} + 360 ° - {θ}_{ReadNonius} , & {θ}_{ReadMaster} < {θ}_{ReadNonius}\end{matrix} \qquad ( 4 )$$
$$n = INT ( \frac{Δθ * {N}_{nonius}}{360 °} ) \qquad ( 5 )$$
$${θ}_{CalcMaster} = n * 360 ° + {θ}_{ReadMaster} \qquad ( 6 )$$
$$\{ \begin{matrix}{S}_{real} = \frac{{θ}_{master}}{360 °} * {P}_{B} \\ {S}_{calc} = \frac{{θ}_{CalcMaster}}{360 °} * {P}_{B}\end{matrix} \qquad ( 7 )$$
wherein Nₘₐₛₜₑᵣ denotes a number of teeth of the master gear; Nₙₒₙᵢᵤₛ denotes a number of teeth of the nonius gear; θₘₐₛₜₑᵣ denotes a multi-turn angle of the master gear; θₙₒₙᵢᵤₛ denotes a multi-turn angle of the nonius gear; MOD denotes a function to find a remainder; θ_{ReadMaster} denotes the single-turn angle of the master gear; θ_{ReadNonius} denotes the single-turn angle of the nonius gear; Δθ denotes the difference between the single-turn angle of the master gear and the single-turn angle of the nonius gear; INT denotes a rounddovn function; n denotes a number of revolutions of the master gear, a range of n being n∈[0,Nₙₒₙᵢᵤₛ); θ_{CalcMaster} denotes a calculated multi-turn angle value of the master gear; P_{B} denotes the lead of the ball screw pair; Sᵣₑₐₗ denotes an actual position of the push rod; and S_{calc} denotes a calculated position of the push rod.
